(19) United States
(12) Patent Application Publication
(10) Pub. No.: US 2026/0112372 A1
(43) Pub. Date: Apr. 23, 2026

(54) METHOD AND SYSTEM FOR IDENTIFYING A SPEAKER OF INTEREST IN AN AUDIO

(71) Applicant: ONIBER SOFTWARE PRIVATE LIMITED, Pune (IN)

(72) Inventors: Raghu Sesha Iyengar, Bangalore (IN); Ankush Tiwari, Pune (IN); Abhijeet Zilpelwar, Pune (IN); Bijay Singh, Pune (IN); Naveen Sharma, Mathura (IN)

(21) Appl. No.: 19/365,227

(22) Filed: Oct. 22, 2025

(30) Foreign Application Priority Data
Oct. 22, 2024 (IN) 202421080345

(51) Int. Cl. G10L 17/06; G10L 17/02; G10L 17/04; G10L 17/18

(52) U.S. Cl. CPC G10L 17/06; G10L 17/02; G10L 17/04; G10L 17/18

(57) ABSTRACT

The present method (300) identifies a speaker of interest in an audio file through a systematic approach. The process begins by receiving an input audio file via a processor (201). The audio file is then split into one or more chunks, followed by the extraction of relevant features from each chunk. Using a transformer encoder model, embeddings of the speaker of interest are generated based on these extracted features. The method identifies one or more nearest neighbours from various data structures corresponding to potential speakers, utilizing a classification model based on the generated embeddings. A set of nearest neighbours is then identified, ensuring that the count exceeds a predefined threshold and that the distance of each neighbour remains below a specified nearest-neighbour distance threshold. Finally, the method provides an identification of the speaker of interest as one of the recognized persons, enhancing speaker recognition capabilities in audio analysis.

### CROSS-REFERENCE TO RELATED APPLICATIONS AND PRIORITY

The present application claim priority from Indian Patent Application No. 202421080345 filed on 22 Oct. 2024.

### TECHNICAL FIELD

The presently disclosed embodiments are related, in general, to the field of audio processing. More particularly, the presently disclosed embodiments are related to a system and method for processing audio data to perform speaker identification using advanced machine learning and data analysis techniques.

### BACKGROUND

This section is intended to introduce the reader to various aspects of art, which may be related to various aspects of the present disclosure that are described or claimed below. This discussion is believed to be helpful in providing the reader with background information to facilitate a better understanding of the various aspects of the present disclosure. Accordingly, it should be understood that these statements in this background section are to be read in this light, and not as admissions of prior art. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Speaker identification systems are widely used in domains such as law enforcement, security, and telecommunications to identify individuals based on their voice samples. These systems rely on various features extracted from voice data, such as time-domain, frequency-domain, or other derived features. The ability to accurately identify individuals based on their voice is critical in scenarios involving forensic analysis, surveillance, and authentication.

Identity verification services play a crucial role in ensuring that user-provided information is associated with a real person's identity. Businesses and government agencies often utilize identity verification methods that involve physical identification materials, such as driver's licenses, passports, and identification cards. These methods may also rely on authoritative sources, including credit bureaus and government databases, to authenticate identity information. Integrating voice identification into these verification processes can enhance security and efficiency, providing an additional layer of verification that goes beyond traditional methods.

Voice identification plays a critical role in many modern applications, including security, authentication, and communication systems. Accurate identification of a speaker's voice is essential for systems such as voice-activated controls, fraud prevention in banking, and forensic investigations. However, traditional techniques for voice identification are often inefficient and limited in their capabilities.

Additionally, in environments where speakers change frequently, such as virtual meetings, it is crucial to not only identify each speaker but also ensure the authenticity of their voice to prevent impersonation or spoofing attempts. The advent of neural network-based audio processing techniques has introduced a more sophisticated approach, leveraging deep learning to capture unique voice features and patterns. Nevertheless, these systems face challenges related to real-time processing, speaker similarity, and variability due to external conditions.

Most existing methods for voice identification rely heavily on user credentials or pre-established user profiles. These approaches typically focus on verifying a user based on prior information, such as stored voice samples or login credentials, rather than analyzing the voice characteristics in real-time. As a result, such methods fail to provide granular-level voice identification, which involves detecting subtle variations in voice patterns that are unique to each individual. This lack of direct voice-based identification leaves significant gaps, especially in scenarios where the user's voice may vary due to mimicry, synthetic voices, or environmental factors.

Existing speaker identification methods typically involve comparing a recorded voice sample with previously stored voice profiles. These systems attempt to identify the speaker by analyzing specific features of the sample, including pitch, tone, and speech patterns. Although these methods can perform well when identifying a speaker from a set of known individuals, challenges remain when attempting to distinguish between original and mimicry voice samples.

The problem of detecting mimicry, where an individual imitates the voice of another person, has not been extensively investigated in existing speaker identification systems. Mimicry detection is essential in cases where adversaries may use imitation to deceive systems or human operators. Without the ability to detect imitation, current systems may falsely attribute the voice to the wrong individual, potentially compromising the accuracy of the identification process.

Moreover, the ability to identify an individual from a set of suspects with high confidence is a common requirement in law enforcement and investigative domains. This involves not only verifying if a speech sample belongs to a particular individual but also ensuring that the sample has not been manipulated or generated artificially.

Therefore, there is a significant need for advanced systems that can not only identify a speaker with high confidence but also detect synthetic or mimicry voice samples. Addressing this challenge would greatly enhance the reliability of speaker identification systems in critical applications, such as security, investigations, and authentication.

### SUMMARY

This summary is provided to introduce concepts related to a method and system for identifying a speaker of interest in an audio file and the concepts are further described below in the detailed description. This summary is not intended to identify essential features of the claimed subject matter nor is it intended for use in determining or limiting the scope of the claimed subject matter.

According to embodiments disclosed herein, a method and system for identifying a speaker of interest in an audio file are described. The method involves receiving an input audio file and splitting the input audio file into multiple chunks for efficient processing. The method involves a step of extracting one or more features from each chunk from the one or more chunks. Further, the method involves utilizing a pre-trained transformer encoder model to generate embeddings that represent the voice characteristics of one or more speakers. In one embodiment, a classification model processes the generated embeddings to identify one or more nearest neighbours from multiple data structures, such as a k-d tree, representing various individuals, based on the generated embeddings. Based on the proximity of the embeddings to the one or more nearest neighbours, the method selects a set of nearest neighbours, count of which falls within a predefined distance threshold, to ensure a reliable match. The method continues by determining the specific speaker of interest if the count of identified nearest neighbours exceeds a preset threshold. This step ensures precise identification of the speaker, allowing the system to confidently distinguish between different individuals and assess the likelihood of mimicry. The system comprises a processor, memory, and a user interface, all working together to carry out the described method steps. The processor executes instructions stored in memory to split the audio, generate embeddings, and perform nearest neighbour identification based on distance metrics. A user interface may facilitate uploading of the audio file, while the processor handles the backend processing to identify the speaker of interest. The disclosed method and system address the challenges of speaker identification by leveraging advanced audio processing techniques and machine learning models. These advancements aim to enhance accuracy in speaker identification and mimicry detection in various applications, such as law enforcement and investigations.

The foregoing summary is illustrative and not intended to limit the scope of the claimed subject matter. Further aspects, embodiments, and features will become apparent by reference to the detailed description and accompanying drawings.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements.

The detailed description is described with reference to the accompanying figures. In the figures, same numbers are used throughout the drawings to refer like features and components. Embodiments of a present disclosure will now be described, with reference to the following diagrams below wherein:

FIG. 1 is a block diagram that illustrates a system (100) for implementing a system for identifying a speaker of interest in an audio file, in accordance with an embodiment of present subject matter.

FIG. 2 is a block diagram that illustrates various components of an application server (101) configured for performing steps for identifying the speaker in the audio file, in accordance with an embodiment of the present subject matter.

FIG. 3 is a flowchart that illustrates a method (300) for identifying the speaker in the audio file, in accordance with an embodiment of the present subject matter.

FIG. 4 illustrates a block diagram (400) of an exemplary computer system for implementing embodiments consistent with the present subject matter.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented, and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment. The terms “comprise”, “comprising”, “include(s)”, or any other variations thereof, are intended to cover a non-exclusive inclusion, such that a setup, system or method that comprises a list of components or steps does not include only those components or steps but may include other components or steps not expressly listed or inherent to such setup or system or method. In other words, one or more elements in a system or apparatus preceded by “comprises . . . a” does not, without more constraints, preclude the existence of other elements or additional elements in the system or apparatus.

The objective of the present disclosure is to provide a method and system that enhances identification of a speaker of interest in audio files. Specifically, the disclosure aims to address the limitations of traditional approaches in voice recognition by introducing advanced embedding techniques and nearest-neighbour classification models. The system is designed to offer high accuracy in distinguishing between original and mimicry voice samples, allowing for reliable identification of individuals from audio recordings. This improvement facilitates effective speaker verification and contributes to various applications, including law enforcement and identity verification services. Another objective of the present disclosure is to provide a system that allows users to efficiently interact with the speaker identification process through a user-friendly interface. The interface ensures ease of use for both technical and non-technical users, enabling quick uploads and processing of audio files while maintaining accurate identification results.

Yet another objective of the present disclosure is to equip users with the ability to track and assess speaker identification results in real-time. This feature allows users to monitor identification accuracy dynamically, thereby enabling adjustments to the recognition strategy based on the evolving nature of the audio inputs.

Yet another objective of the present disclosure is to implement mechanisms that allow users to optimize the speaker identification process, securing accurate results based on the analysis of audio samples. This approach aids users in maximizing identification accuracy while minimizing false positives.

Yet another objective of the present disclosure is to provide a transparent system where users can view real-time updates on the identification process, including the status of audio sample analysis and results. This transparency ensures user confidence in the accuracy of the system.

Yet another objective of the present disclosure is to integrate adaptive features, such as progress indicators, to inform users of the system's current status and upcoming tasks. This aims to enhance user engagement and streamline the identification process.

Yet another objective of the present disclosure is to enhance overall user satisfaction by offering a flexible and responsive environment that supports strategic identification approaches. This includes providing customizable settings based on user preferences. Yet another objective of the present disclosure is to utilize a classification model with dynamic threshold adjustments to ensure that the identification process operates fairly and accurately. This aims to maintain integrity and trust in the identification system. Yet another objective of the present disclosure is to allow users to effectively manage their identification efforts by offering a dashboard that provides insights into the recognition process, including the performance of the system and comparative analysis of audio samples.

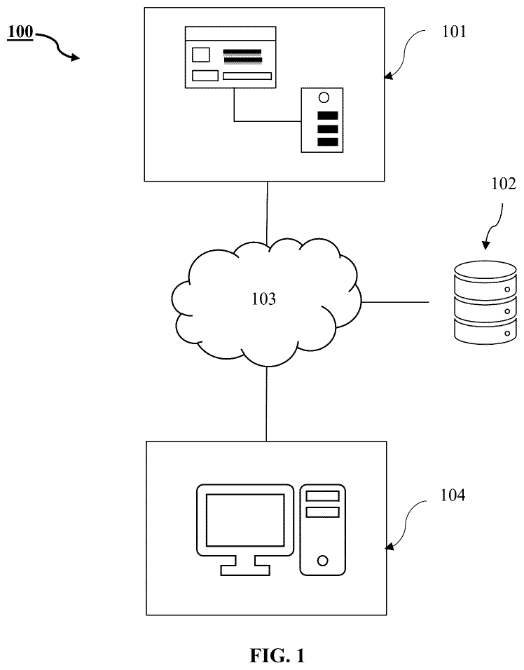

FIG. 1 is a block diagram that illustrates a system (100) for identifying the speaker of interest in the audio file, in accordance with an embodiment of present subject matter. The system (100) typically includes, an application server (101), a database server (102), a communication network (103), and one or more portable devices (104). The application server (101), the database server (102), and the one or more portable devices (104) are typically communicatively coupled with each other via the communication network (103). In an embodiment, the application server (101) may communicate with the database server (102), and one or more portable devices (104) using one or more protocols such as, but not limited to, Hypertext Transfer Protocol (HTTP), Transmission Control Protocol/Internet Protocol (TCP/IP), Wireless Application Protocol (WAP), RF mesh, Bluetooth Low Energy (BLE), and the like, to communicate with one another.

In one embodiment, the database server (102) may refer to a computing device configured to store received input audio files, pre-processed input audio files, extracted one or more features and generated embeddings corresponding to each chunk from the one or more chunks, identify one or more nearest neighbours of one or more persons and provide identification of the speaker of interest from the one or more persons. This data may include user profiles, audio sample repositories, speaker embeddings, classification models, and other parameters essential for executing the method of identifying the speakers of interest in the audio files. The database server (102) may ensure that data is securely stored, readily accessible, and accurately updated to support real-time identification and adaptive processing within the system (100). In an embodiment, the database server (102) may include a special purpose operating system specifically configured to perform one or more database operations on the received input audio file. In an embodiment, the database server (102) may include one or more instructions specifically for storing the training data used to enhance the performance of the system's models including a feeder neural network model, and a transformer encoder model.

In an embodiment, the database server (102) may be a specialized operating system configured to perform one or more database operations on the stored content. Examples of database operations include but are not limited to, storing, retrieving, comparing, selecting, inserting, updating, and deleting audio samples, speaker embeddings, and user profiles. This specialized operating system optimizes the efficiency and accuracy of data management, ensuring that the system can quickly respond to real-time requests for identifying the speaker of interest. In an embodiment, the database server (102) may include hardware that may be configured to perform one or more predetermined operations. In an embodiment, the database server (102) may be realized through various technologies such as, but not limited to, Microsoft® SQL Server, Oracle®, IBM DB2®, Microsoft Access®, PostgreSQL®, MySQL®, SQLite®, distributed database technology and the like. In an embodiment, the database server (102) may be configured to utilize the application server (101) for implementing the method for identifying the speaker of interest in the audio file.

A person with ordinary skills in art will understand that the scope of the disclosure is not limited to the database server (102) as a separate entity. In an embodiment, the functionalities of the database server (102) can be integrated into the application server (101) or into the one or more portable device (104).

In an embodiment, the application server (101) may refer to a computing device or a software framework hosting an application, or a software service. In an embodiment, the application server (101) may execute procedures such as, but not limited to, programs, routines, or scripts stored in one or more memory units to support the operation of the hosted application or software service. In an embodiment, the hosted application is configured to perform predetermined operations, including processing audio files, generating speaker embeddings, identifying one or more nearest neighbours and facilitating real-time identification of the person of interest from the audio samples. The application server (101) may be realized through various types of application servers such as, but are not limited to, a Java application server, a. NET framework application server, a Base4 application server, a PHP framework application server, or any other application server framework.

In an embodiment, the application server (101) may be configured to utilize the database server (102) and the one or more portable device (104), in conjunction, with implementing the method for identifying the speaker of interest in the audio file. In an implementation, the application server (101) is configured for an automated processing of the audio file in various formats, such as MP3, WAV, and AAC, to identify synthetic portions within the input audio file by performing various operations including pre-processing, splitting of the pre-processed input audio file, and extracting of the one or more features. Further, the application server (101) provides the one or more features corresponding to each chunk from the one or more chunks to both the feeder neural network model and the transformer encoder model. Each chunk is further identified as one or more nearest neighbours based on the embeddings generated from the transformer encoder model. Further, the nearest neighbour identification is determined using a classification model that analyzes the distances between the embedding vectors and data structures of embeddings associated with known persons. This process ensures the identification of the speaker of interest for subsequent operations such as verification or mimicry detection, is performed by the application server (101).

In an implementation, the application server (101) corresponds to an infrastructure for implementing the method for identifying the speaker of interest in the audio file. Further, the method may comprise one or more stages of audio analysis. Further, each stage from the one or more stages may comprise one or more steps, such as splitting the audio file into chunks, generating speaker embeddings, and identifying the nearest neighbours.

In an embodiment, the application server (101) may be configured to receive the input audio file.

In another embodiment, the application server (101) may be configured to split the input audio file into the one or more chunks.

In yet another embodiment, the application server (101) may be configured to extract one or more features corresponding to each chunk from the one or more chunks.

In yet another embodiment, the application server (101) may be configured to generate embeddings of one or more speakers, using the transformer encoder model based on the extracted one or more features.

In yet another embodiment, the application server (101) may be configured to classify each chunk from the one or more chunks as one or more nearest neighbours based on the generated embeddings. This classification process utilizes the embeddings produced by the transformer encoder model to analyze one or more nearest neighbours from one or more data structures corresponding to each person from one or more persons available on the database server (102), based on the generated embeddings of each chunk. By leveraging advanced machine learning techniques, the application server effectively distinguishes a set of nearest neighbours from the one or more nearest neighbours, corresponding a person from the one or more persons based on a count of the set of nearest neighbours greater than a predefined threshold and enhancing the overall accuracy of the identification of speaker of interest in the input audio file.

In yet another embodiment, the application server (101) may be configured to provide an identification of the speaker of interest as the person from the one or more persons. The application server (101) may be configured to present to the user, via a user interface (UI), each chunk from the one or more chunks, along with the identification of the chunk identified as corresponding to the speaker of interest or not. This interactive feature allows the user to view, in real-time, the results of the classification process, providing a clear and intuitive display of the identification status for each chunk within the input audio file. By visualizing the classification results, users can easily assess the authenticity of the audio segments, thereby improving confidence in the system's capabilities for identifying the speaker of interest.

In an embodiment, the communication network (103) may correspond to a communication medium through which the application server (101), the database server (102), and the one or more portable device (104) may communicate with each other. Such communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), Wireless Application Protocol (WAP), File Transfer Protocol (FTP), ZigBee, EDGE, infrared IR), IEEE 802.11, 802.16, 2G, 3G, 4G, 5G, 6G, 7G cellular communication protocols, and/or Bluetooth (BT) communication protocols. The communication network (103) may either be a dedicated network or a shared network. Further, the communication network (103) may include a variety of network devices, including routers, bridges, servers, computing devices, storage devices, and the like. The communication network (103) may include, but is not limited to, the Internet, intranet, a cloud network, a Wireless Fidelity (Wi-Fi) network, a Wireless Local Area Network (WLAN), a Local Area Network (LAN), a cable network, the wireless network, a telephone network (e.g., Analog, Digital, POTS, PSTN, ISDN, xDSL), a telephone line (POTS), a Metropolitan Area Network (MAN), an electronic positioning network, an X.25 network, an optical network (e.g., PON), a satellite network (e.g., VSAT), a packet-switched network, a circuit-switched network, a public network, a private network, and/or other wired or wireless communications network configured to carry data.

In an embodiment, the one or more portable devices (104) may refer to a computing device used by a user. The one or more portable devices (104) may comprise of one or more processors and one or more memory. The one or more memories may include computer readable code that may be executable by one or more processors to identifying the speaker of interest in the audio file. In an embodiment, the one or more portable devices (104) may present a web user interface for user participation in the environment using the application server (101). Example web user interfaces presented on the one or more portable devices (104) to display the real-time identification status of each chunk from the input audio file, indicating whether the chunk corresponds to the speaker of interest or other individuals, along with additional metrics such as nearest-neighbour distances, and processed audio features. Examples of the one or more portable devices (104) may include, but are not limited to, a personal computer, a laptop, a computer desktop, a personal digital assistant (PDA), a mobile device, a tablet, or any other computing device.

The system (100) can be implemented using hardware, software, or a combination of both, which includes using where suitable, one or more computer programs, mobile applications, or “apps” by deploying either on-premises over the corresponding computing terminals or virtually over cloud infrastructure. The system (100) may include various micro-services or groups of independent computer programs which can act independently in collaboration with other micro-services. The system (100) may also interact with a third-party or external computer system. Internally, the system (100) may be the central processor of all requests for transactions by the various actors or users of the system. A critical attribute of the system (100) for identifying the speaker of interest in the audio file is that it can concurrently and instantly perform the identification of the specific person of interest or speaker of interest from the audio file along with streaming of the audio file.

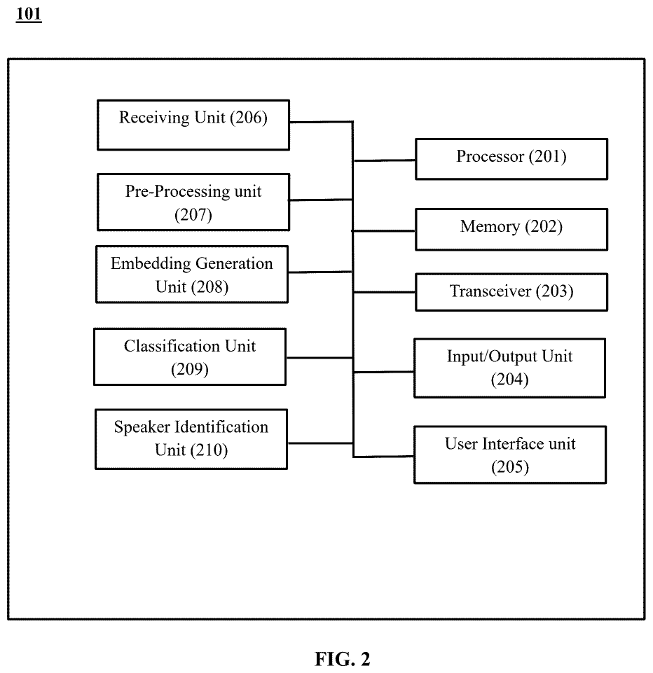

FIG. 2 illustrates a block diagram illustrating various components of the application server (101) configured for identifying the speaker of interest in the audio file, in accordance with an embodiment of the present subject matter. Further, FIG. 2 is explained in conjunction with elements from FIG. 1. Here, the application server (101) preferably includes a processor (201), a memory (202), a transceiver (203), an Input/Output unit (204), a User Interface unit (205), a Receiving unit (206), a Pre-Processing unit (207), an Embedding generation unit (208), a Classification unit (209) and a Speaker Identification unit (210). The processor (201) is further preferably communicatively coupled to the memory (202), the transceiver (203), the Input/Output unit (204), the User Interface unit (205), the receiving unit (206), the Pre-Processing unit (207), the Embedding generation unit (208), the Classification unit (209) and the Speaker Identification unit (210), while the transceiver (203) is preferably communicatively coupled to the communication network (103).

In an embodiment, the application server (101) may be configured to receive the input audio file, via a user interface (UI), for the purpose of identifying a speaker of interest. The application server (101) may then pre-process the received input audio file to prepare it for further analysis. Subsequently, the application server (101) may be configured to split the pre-processed audio file into one or more chunks. Furthermore, the application server (101) may be configured to extract the one or more features corresponding to each chunk from the one or more chunks. Furthermore, the application server (101) may be configured to generate embeddings of each chunk from the one or more chunks, using the transformer encoder model based on the extracted one or more features. Additionally, the application server (101) may classify, via the classification unit (209), each chunk to determine one or more nearest neighbours based on the generated embeddings. Moreover, the application server (101) may provide an identification of the speaker of interest.

The processor (201) comprises suitable logic, circuitry, interfaces, and/or code that may be configured to execute a set of instructions stored in the memory (202), and may be implemented based on several processor technologies known in the art. The processor (201) works in coordination with the transceiver (203), the Input/Output unit (204), the User Interface unit (205), the receiving unit (206), the Pre-Processing unit (207), the Embedding generation unit (208), the Classification unit (209) and the Speaker Identification unit (210) for identifying the speaker of interest in the audio file. Examples of the processor (201) include, but not limited to, standard microprocessor, microcontroller, central processing unit (CPU), an X86-based processor, a Reduced Instruction Set Computing (RISC) processor, an Application-Specific Integrated Circuit (ASIC) processor, and a Complex Instruction Set Computing (CISC) processor, distributed or cloud processing unit, state machines, logic circuitries, and/or any devices that manipulate signals based on operational instructions and/or other processing logic that accommodates the requirements of the present invention.

The memory (202) comprises suitable logic, circuitry, interfaces, and/or code that may be configured to store the set of instructions, which are executed by the processor (201). Preferably, the memory (202) is configured to store one or more programs, routines, or scripts that are executed in coordination with the processor (201). Additionally, the memory (202) may include any computer-readable medium or computer program product known in the art including, for example, volatile memory, such as static random-access memory (SRAM) and dynamic random-access memory (DRAM), and/or non-volatile memory, such as read only memory (ROM), erasable programmable ROM, a Hard Disk Drive (HDD), flash memories, Secure Digital (SD) card, Solid State Disks (SSD), optical disks, magnetic tapes, memory cards, virtual memory and distributed cloud storage. The memory (202) may be removable, non-removable, or a combination thereof. Further, the memory (202) may include routines, programs, objects, components, data structures, etc., which perform particular tasks or implement particular abstract data types. The memory (202) may include programs or coded instructions that supplement the applications and functions of the system (100). In one embodiment, the memory (202), amongst other things, may serve as a repository for storing data processed, received, and generated by one or more of the programs or coded instructions. In yet another embodiment, the memory (202) may be managed under a federated structure that enables the adaptability and responsiveness of the application server (101).

The transceiver (203) comprises suitable logic, circuitry, interfaces, and/or code that may be configured to receive, process or transmit information, data or signals, which are stored by the memory (202) and executed by the processor (201). The transceiver (203) is preferably configured to receive, process or transmit, one or more programs, routines, or scripts that are executed in coordination with the processor (201). The transceiver (203) is preferably communicatively coupled to the communication network (103) of the system (100) for communicating all the information, data, signal, programs, routines or scripts through the network (103).

The transceiver (203) may implement one or more known technologies to support wired or wireless communication with the communication network (103). In an embodiment, the transceiver (203) may include but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. Also, the transceiver (203) may communicate via wireless communication with networks, such as the Internet, an Intranet and/or a wireless network, such as a cellular telephone network, a wireless local area network (LAN) and/or a metropolitan area network (MAN). Accordingly, the wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The input/output (I/O) unit (204) comprises suitable logic, circuitry, interfaces, and/or code that may be configured to receive or present information. The input/output unit (204) comprises various input and output devices that are configured to communicate with the processor (201). Examples of the input devices include, but are not limited to, a keyboard, a mouse, a joystick, a touch screen, a microphone, a camera, and/or a docking station. Examples of the output devices include, but are not limited to, a display screen and/or a speaker. The I/O unit (204) may include a variety of software and hardware interfaces, for example, a web interface, a graphical user interface, and the like. The I/O unit (204) may allow the system (100) to interact with the user directly or through the portable devices (104). Further, the I/O unit (204) may enable the system (100) to communicate with other computing devices, such as web servers and external data servers (not shown). The I/O unit (204) can facilitate multiple communications within a wide variety of networks and protocol types, including wired networks, for example, LAN, cable, etc., and wireless networks, such as WLAN, cellular, or satellite. The I/O unit (204) may include one or more ports for connecting a number of devices to one another or to another server. In one embodiment, the I/O unit (204) allows the application server (101) to be logically coupled to other portable devices (104), some of which may be built in. Illustrative components include tablets, mobile phones, desktop computers, wireless devices, etc.

Further, the input/output (I/O) unit (204) comprising input device namely keyboard, touchpad, trackpad may be configured to receive the input audio file via the user interface. In an embodiment, the microphone may be configured to receive the input audio file from the user. Additionally, the system (100) may allow users to upload audio files from external storage devices or cloud services, enabling versatile methods for inputting audio for analysis.

Further, the user interface unit (205) may include the user interface (UI) displaying specific operations such as receiving the input audio file and presenting the classified input audio file to the user. The user interface unit (205) may feature the user interface (UI) designed to facilitate interaction with the system (100) for audio analysis. In an exemplary embodiment, the UI may allow users to upload the input audio file for analysis. In an exemplary embodiment, the UI may allow users to select one or more portions from the audio file for analysis. In another exemplary embodiment, the user interface (UI) may allow users to select specific chunks from the one or more chunks to determine the speaker of interest. Users can interact with the UI through voice or text commands to initiate various operations, such as executing speaker identification tasks or adjusting parameters based on their preferences. In an exemplary embodiment, the UI may display the current status of the speaker identification process and provide real-time feedback on the classification results. Additionally, the user interface unit (205) supports multiple content formats, including text, audio, and visual indicators, enabling users to interact with the system seamlessly. This functionality allows users to manage and customize speaker identification tasks in real-time, ensuring their specific needs are met. Moreover, the user interface unit (205) presents relevant information, alerts, and notifications regarding the identification outcomes, enhancing user engagement with the system (100). This approach overcomes the limitations of conventional systems by accurately identifying the speaker of interest in the received input audio file.

In an embodiment, the receiving unit (206) of the application server (101), is disclosed. The receiving unit (206) may be configured to receive an input audio file, via the processor (201). The input audio file may comprise audio samples of one or more speakers. In an exemplary embodiment, the receiving unit (206) may allow the system to receive the audio files in various formats, such as WAV, MP3, or AAC. In an exemplary embodiment, the receiving unit (206) may verify the file format and size to ensure compatibility with the system's processing capabilities. Upon successful validation, the unit transmits the audio file to the processor (201) for further analysis.

Further, the pre-processing unit (207) may be configured to pre-process the received input audio file. Furthermore, the pre-processing unit (207) may split the input audio file into one or more chunks. In an embodiment, the splitting of the input audio file into the one or more chunks may be performed by using a pre-determined time interval. In another embodiment, the splitting of the input audio file into the one or more chunks may be performed based on the audio samples of the one or more speakers present in the audio file. Additionally, the input audio file may contain audio samples from one or more speakers, enabling the system to analyze speaker-specific data effectively. In an exemplary embodiment, after receiving the pre-processed input audio file, the pre-processing unit (207) may be activated to segment the audio into the one or more chunks. For example, if the pre-processed audio file is 60 seconds long, the pre-processing unit (207) may be configured to divide the audio into four 15-second segments. This splitting allows for easier analysis of features corresponding to each chunk, enabling the system to process the audio in smaller, more focused segments. Further, the pre-processing unit (207) may be configured to pre-process the received input audio file before splitting. The pre-processing unit (207) may sample the received input audio file at a predefined sampling rate to obtain a sampled input audio file. Further the preprocessing unit (207) may filter the sampled audio file in the time domain to reduce noise or artifacts in the frequency domain. In an exemplary embodiment, filtering of the sampled input audio file may be performed using one of hamming window, hanning window, low pass filter, high pass filter, band pass filter or a combination thereof. The pre-processing unit (207) may process these one or more chunks to enable further analysis by a pre-trained audio transformer.

In an exemplary embodiment, the pre-processing unit (207) receives the audio file containing background noise, such as a recording of a person speaking in a crowded cafe. For example, upon receiving the audio file, the pre-processing unit (207) may sample the audio to the predefined sampling rate of 16 kHz, optimizing it for further analysis. For example, the pre-processing unit (207) may apply a low-pass filter in the time domain to remove high-frequency noise, such as chatter and clinking dishes, ensuring that the primary speech signal remains clear. The resulting pre-processed audio file is then ready for further analysis.

In yet another embodiment, the pre-processing unit (207) may be configured to pre-process the received input audio file to identify one or more portions associated with the one or more speakers within the received input audio file. The identification of these one or more portions may be based on user input, wherein the user selects the one or more portions associated with a specific speaker from the one or more speakers for further analysis. Once identified, these one or more portions may be used to facilitate the process of identifying the speaker of interest by isolating relevant audio segments, thus improving the accuracy and efficiency of the speaker identification process. The pre-processing unit (207) may also ensure that the selected portions are correctly aligned with the corresponding speakers within the audio file, ensuring consistent processing across various segments. In an exemplary embodiment, the user may select a portion of the audio file containing a female voice from a recording with both male and female voices, focusing on identifying speaker of interest audio or mimicry audio specifically within the female voice section. Further, the pre-processing unit (207) is configured to pre-process the input audio file, isolating the selected portion including the female voice for further analysis. This ensures that only the relevant portion of the audio, as specified by the user, is analysed for potential synthetic manipulations, improving accuracy and efficiency.

Further, each chunk, after being split by the pre-processing unit (207), may partially overlap with an adjacent chunk, ensuring continuity of audio data between consecutive chunks.

In an exemplary embodiment, the splitting of the audio file into overlapping chunks may significantly enhance the capture of temporal features and contextual information. For example, consider a 3-second audio. If we split this audio into non-overlapping chunks, we would end up with segments like 0-1 seconds, 1-2 seconds, and 2-3 seconds. While this approach provides distinct segments, it may lead to a loss of information that occurs at the boundaries of each chunk. By introducing a 50% overlap, the chunks become 0-1 seconds, 0.5-1.5 seconds, 1-2 seconds, 1.5-2.5 seconds, and 2-3 seconds. This overlapping ensures that each chunk from the one or more chunks shares half of its data with adjacent chunks. This protects the one or more audio features that stretch across chunk boundaries and improves the accuracy of the system for analysis of the speaker of interest.

In another exemplary embodiment, when the audio is split into chunks in the time domain, it may cause undesirable artifacts in the frequency domain. To avoid this, the audio chunk is processed using filters. For example, the filters such as hamming window, hanning window helps to protect the audio quality during processing.

Furthermore, the pre-processing unit (207) may be configured to extract one or more features corresponding to each chunk from the one or more chunks. For example, each chunk may be individually examined for features such as pitch, background noise, and vocal content, facilitating more accurate classification in subsequent processing steps. In an exemplary embodiment, the one or more features may include one of a mel spectrogram, vocal tract model parameters, acoustic parameters, background noise, raw sample, pitch, frequency changes, file format or a combination thereof.

In an embodiment, the pre-processing unit (207) may be configured for stacking the extracted one or more features, prior to their input into a feeder neural network model, thereby creating a volume of input for the feeder neural network model, which aids in optimizing the input for further processing by a transformer encoder model. In an exemplary embodiment, the feeder neural network model may correspond to one of a convolutional neural network (CNN) layers, fully connected layers, sigmoid activation, ReLU (Rectified Linear Unit) activation, dropout layers, ResNet (Residual Networks), RawNet2, Deep Neural Network (DNN), or a combination thereof.

Furthermore, the embedding generation unit (208) may be configured to generate embeddings of the one or more speakers, using a transformer encoder model based on the extracted one or more features. Furthermore, the transformer encoder model may be configured to generate embeddings of each chunk from the one or more chunks of the one or more speakers, based on the extracted one or more features. In an embodiment, the embeddings generated by the transformer encoder model may be multi-dimensional vector representation of each chunk from the one or more chunks. Furthermore, the embedding generation unit (207) may be configured to input the extracted one or more features into the feeder neural network model based on the created volume of input before passing them to the transformer encoder model, for obtaining a changed activation volume of an input of the transformer encoder model. In an exemplary embodiment, transformer encoder model may correspond to one of pre-trained audio transformer, Audio Spectrogram Transformer model, a Whisper transformer encoder model, Wav2Vec2, a custom transformer-based neural network model, EnCodec, Hubert (Hidden-Unit BERT), or a combination thereof, for audio processing.

In an exemplary embodiment, in case of the transformer encoder model, the feeder neural network may generate an activation volume that aligns with the specific input dimensions expected by the transformer encoder model. For example, if the input expected by the Audio Spectrogram Transformer model is structured as 16×128×128×1, where each of the 16 stacked spectrograms has a resolution of 128×128 with a single channel (audio intensity), the feeder neural network model is designed to produce an output activation volume that meets this requirement. Thus, the embedding generation unit (208) ensures that the output activation volume of the feeder neural network model matches the input dimensions expected by the transformer encoder model, enabling seamless data flow and ensuring effective training of both models.

In an exemplary embodiment, embeddings may correspond to numerical vector representations of each chunk from the one or more chunks based on the extracted one or more features. For example, in case of an Audio Spectograph Transformer model, the encoder processes the input audio chunk and generates a 768-dimensional embedding that captures the essential features of the audio. This embedding compresses complex audio information into a vector format, which can be used by the system for further analysis, such as classifying whether each chunk corresponds to the speaker of interest or a mimicry data. Furthermore, embedding generation unit (208) may utilize one or more data structures to efficiently store and retrieve embeddings generated from the input audio file. The one or more data structures may be used to store embeddings of one or more persons. These one or more data structures may include, but not limited to k-d tree structures, Ball tree, Quadtree, Octree, hierarchical data structure, hash maps, graph-based structures, multidimensional arrays, indexed databases, or a combination thereof each optimized for different aspects of searching and retrieval. For instance, k-d tree structures may be utilized to efficiently store and retrieve embeddings corresponding to various speakers, enabling fast identification of nearest neighbours.

In one embodiment, the classification unit (209) may be configured to utilize a classification model to identify one or more nearest neighbours from the one or more data structures corresponding to each person from the one or more persons, based on the generated embeddings. In an embodiment, the classification unit (209) may be configured to train the classification model using the one or more chunks of the input audio file. The training process may involve utilizing a dataset of voice samples. The dataset of voice samples may comprise the audio samples of the one or more speakers, embeddings of the one or more speakers, labelled mimicry samples of the one or more speakers, stored in the one or more data structures. During the training, the classification model may be configured to apply one or more loss functions on the dataset of voice samples to detect incorrect classifications. Upon identifying a wrong classification, the classification unit (209) may update the classification model using a back propagation technique to enhance its accuracy. The one or more loss functions may include, but are not limited to, cross-entropy loss, triplet loss, and L2 regularizer, or a combination thereof, thereby refining the model's ability to differentiate between correct and wrong classifications and improve the overall speaker identification process.

In one embodiment, the classification model may be configured to obtain a distance of each embedding from the generated embeddings of the one or more speakers with the stored embeddings of the one or more persons using the one or more k-d tree structures. The one or more k-d tree structures may comprise a set of k-d tree structures and a set of mean k-d tree structures. The set of k-d tree structures correspond to the k-d tree structures containing embeddings of each person of the one or persons in the training dataset. The training dataset may comprise a set of k-d tree structures of each person from the one or more persons. The set of k-d tree structures of a person from the one or more persons may comprise embeddings corresponding to one or more utterances of the person. The set of mean k-d tree structures correspond to the k-d tree structures containing mean embeddings of each person of the one or persons in the training dataset. The training dataset may comprise the set of mean k-d tree structures of each person from the one or more persons. The set of mean k-d tree structure of a person from the one or more persons may comprise mean embeddings corresponding to one or more utterances of the person. The classification model may compare the distance of each embedding from the generated embeddings of the one or more speakers with a predefined nearest-neighbour distance threshold to identify the one or more nearest neighbours. Furthermore, the classification unit (209) may identify a set of nearest neighbours from the one or more nearest neighbours corresponding to the person from the one or more persons. The classification unit (209) may compare a count of the set of nearest neighbours with a predefined threshold to identify the set of nearest neighbours from the one or more nearest neighbours. The count of the set of nearest neighbours must be greater than the predefined threshold to become the set of nearest neighbours from the one or more nearest neighbours. In one embodiment, the predefined threshold may be indicative of a predefined percentage of a combination of a count of the set of k-d tree structures and a count of the set of mean k-d tree structures corresponding to the person from the one or more persons. The classification model correspond to but not limited to logistic regression, random forest, k-nearest neighbour (k-NN), support vector machines (SVM), or a combination thereof, for facilitating precise and efficient speaker identification. Additionally, the classification unit (209) may ensure that the distance of each member of the set of nearest neighbours is less than the predefined nearest-neighbour distance threshold, enhancing the reliability and precision of the speaker identification process. In an exemplary embodiment, embeddings may be defined as vector representations of input data processed by the classification unit (209). The neural network models employed within the system may operate by transforming various types of input data, including audio, video, and images, into a vector of fixed dimensions. This vector representation is referred to as an embedding. For example, in the case of the Audio Spectrogram Transformer, the encoder is configured to generate an embedding vector of size 768. This fixed-size vector serves as a compact representation of the input data, enabling efficient processing and analysis within the classification unit (209) of the system (100). In an exemplary embodiment, the input audio chunk may first be processed by the transformer encoder model, which converts the input into an embedding, represented as the high-dimensional vector such as the 768-dimensional vector in case of the Audio Spectograph Transformer model. Furthermore, the classification unit (209) may be trained to transform these embeddings into a two-dimensional vector [a, b], where a=1−b. In an embodiment, the output “a” may represent the probability of the input audio chunk being classified as real, while “b” may represent the probability of the input audio chunk being classified as synthetic.

In one embodiment, the classification model utilized by the classification unit (209) is trained on a comprehensive dataset of voice samples. This dataset includes voice samples from the one or more speakers, as well as their corresponding embeddings. Additionally, the dataset may contain labelled mimicry samples of the one or more speakers, enabling the classification model to effectively differentiate between authentic voice samples and those that are mimicked. This training approach enhances the model's accuracy and reliability in identifying and distinguishing between various speakers based on their unique vocal characteristics.

In one embodiment, the transformer encoder model utilized by the embedding generation unit (208) is trained using the dataset of voice samples specifically for the purpose of identifying the one or more speakers. The transformer encoder model may correspond to one of the following models but not limited to, pre-trained audio transformer, an Audio Spectrogram Transformer, a Whisper Transformer Encoder, a Wave2Vec Transformer, or a custom transformer-based neural network model designed for audio processing. This diverse range of model options allows the system to leverage the strengths of different transformer architectures, optimizing the accuracy and efficiency of speaker identification based on the unique characteristics of the audio input.

In one embodiment, the classification unit (209) may be configured to identify one or more nearest neighbours corresponding to a specific person of interest from the one or more speakers. This identification process utilizes the classification model that operates on the embeddings generated from the input audio file. The nearest neighbours are derived from one or more k-d tree structures, which facilitate efficient searching and retrieval of similar data points within the embedding space. The identification of these nearest neighbours is critical for accurately determining the presence of the specific person of interest in the audio file, thereby enhancing the overall performance and reliability of the speaker identification system.

In an embodiment, the speaker identification unit (210) may be further configured to determine the specific person of interest from the input audio file if the count of the identified set of nearest neighbours exceeds a predefined k-d tree threshold. The speaker identification unit (210) is designed to ensure that the embedding vector such as a vector of dimension 768 obtained from the Audio Spectrogram Transformer can effectively distinguish between real voice samples and mimicry. The use of a “triplet” loss function plays a critical role in achieving this differentiation. Upon fine-tuning the model, the distance between the embedding vectors of real samples will be minimized, while the distance between the embedding vectors of real and mimicry samples will remain significantly larger. Thus, a threshold on this distance can be employed to ascertain whether a given sample is an authentic representation or a mimicry.

In an embodiment, the speaker identification unit (210) is configured to provide an identification of the speaker of interest as the person from the one or more persons. The identification of the speaker of interest comprises information about the person from the one or more persons. In an embodiment, the speaker identification unit (210) may also comprise functionality for determining whether the one or more chunks corresponding to the specific person of interest represent real audio or mimicry. This dual capability enhances the system's effectiveness in distinguishing authentic voice recordings from impersonations.

In an embodiment, the speaker identification unit (210) may further comprise the ability to present to the user information regarding the determined specific person of interest within the input audio file. This feature facilitates user engagement and enhances the overall utility of the system by providing actionable insights based on the identified audio samples.

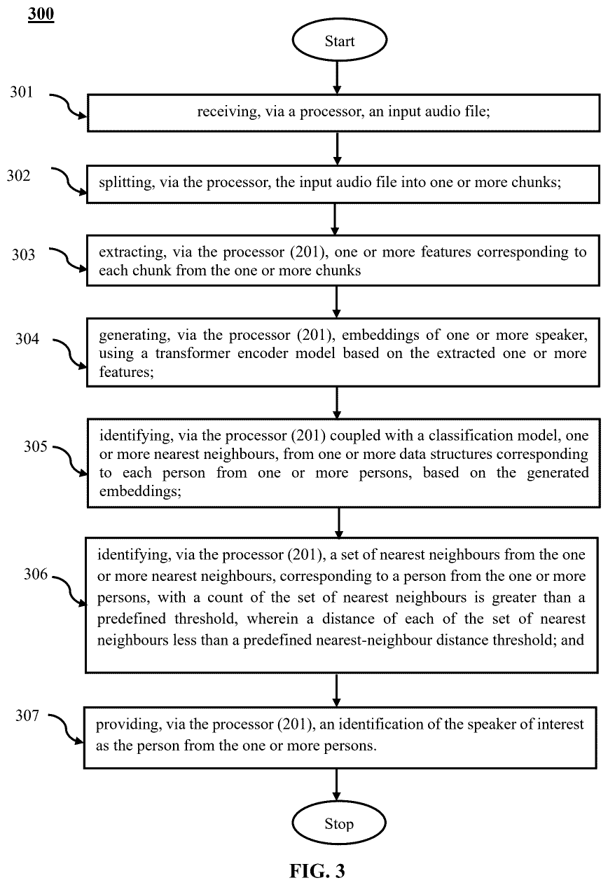

Referring to FIG. 3, a flowchart that illustrates a method (300) for identifying the speaker in the audio file, in accordance with at least one embodiment of the present subject matter. The method (300) may be implemented by one or more portable devices (104) including one or more processors (201) and a memory (201) communicatively coupled to the processor (201). The memory (202) is configured to store processor-executable programmed instructions, causing the processor to perform the following steps:

At step (301), the processor (201) is configured to receive the input audio file. This includes acquiring audio data from a user interface unit and ensuring that the audio file encompasses relevant information from one or more speakers. The input audio file may be in various formats and is prepared for subsequent processing.

At step (302), the processor (201) is configured to split the input audio file into one or more chunks, facilitating detailed analysis of smaller segments of audio, which may enhance the accuracy of feature extraction.

At step (303), the processor (201) is configured to extract one or more features corresponding to each chunk from the one or more chunks. These features may include spectral characteristics, temporal attributes, or other relevant audio information that contributes to identifying the speaker.

At step (304), the processor (201) is configured to generate embeddings of one more speaker using the transformer encoder model based on the extracted one or more features. These embeddings serve as compact numerical representations of the audio features, enabling efficient comparison and analysis.

At step (305), the processor (201) is coupled with the classification model to identify one or more nearest neighbours from one or more data structures corresponding to each person from one or more persons, based on the generated embeddings. This process allows for the determination of audio segments that are similar to those associated with known speakers.

At step (306), the processor (201) is configured to identify the set of nearest neighbours from the one or more nearest neighbours, corresponding to the person from the one or more persons, with the count of the set of nearest neighbours exceeding the predefined threshold. This step is crucial for ensuring reliable identification, as the distance of each of the set of nearest neighbours is maintained below the predefined nearest-neighbour distance threshold.

At step (307), the processor (201) is configured to provide an identification of the speaker of interest as the person from the one or more persons. This identification process is pivotal in facilitating applications such as speaker verification, personalized audio experiences, and enhanced user interaction based on speaker recognition.

Let us delve into a detailed working example of the present disclosure.

Consider a scenario in a digital meeting platform where multiple speakers are present, and the goal is to accurately identify each speaker's contributions and determine if the voice of the identified speaker is original or mimicry.
Audio Input: During the meeting, the platform captures an audio file containing the voices of multiple speakers. The audio file is transmitted to a system implementing the disclosed method for speaker identification.
Audio Splitting: The system first receives the input audio file via the processor and splits it into smaller chunks. These chunks are created either based on predefined time intervals or by detecting the distinct speech patterns of the individual speakers, ensuring that the audio segments contain meaningful units for further analysis.
Embedding Generation: Each audio chunk is then processed by a pre-trained audio transformer. This transformer generates embeddings a high-dimensional representation of the audio characteristics of the speakers in each chunk. These embeddings capture unique vocal features, enabling the system to distinguish between different speakers even in overlapping or noisy environments.
Nearest Neighbour Search: The system uses a classification model to analyse the embeddings and compares them with a k-d tree structure containing reference embeddings of known speakers, including a specific person of interest. The k-d tree helps to identify one or more nearest neighbours, i.e., embeddings that are closest in terms of similarity to the voices in the audio file.
Speaker Identification: From the identified nearest neighbours, the system filters those that have a distance below a predefined threshold. These represent speakers whose voices match closely with the reference data.
Determining the Person of Interest: If the count of nearest neighbours matching the specific person of interest exceeds a predefined threshold, the system determines that the person of interest has been identified in the audio file.
Mimicry Detection: The system further analyzes the embeddings using triplet loss functions, which compare the distance between embeddings of real voice samples and potential mimicry samples. If the distance between the embedding of the identified speaker and the mimicry reference is larger than the set threshold, the system determines that the identified speaker's voice is genuine and not an imitation.

The system presents the results to the user via a user interface, identifying the contributions of the specific person of interest and informing whether the voice was original or a mimicry.

In this scenario, the disclosed method provides an efficient and accurate way of identifying speakers in real-time digital meetings, along with the additional capability of detecting voice mimicry. This functionality is critical for applications where voice authentication and speaker attribution are essential, such as in legal proceedings, remote conferences, or secure communications.

Let us delve into another detailed working example of the present disclosure.

Consider a scenario where a security agency is tasked with identifying a speaker from an audio recording of a conversation. The goal is to match the speaker's voice with known suspects, using pre-trained machine learning models, and determine whether the voice is real or mimicry.

### Step 1: Collection and Curation of the Dataset

To enable accurate identification, a dataset is curated containing voice samples from various individuals, including labelled mimicry data (i.e., recordings where individuals are mimicking other voices). The dataset encompasses different voice patterns, accents, and vocal features. These voice samples are stored in a structured format and prepared for use in training a neural network model.

### Step 2: Training the Base Network

A base network, constructed using a transformer-based audio processing architecture (e.g., Audio Spectrogram Transformer), is trained on the curated dataset. The training process optimizes the network using cross-entropy loss for classification tasks and triplet loss for improving the separability of embeddings. During training, the network learns to identify distinct voice features and generate embeddings, which are vector representations of the audio input. These embeddings capture the unique characteristics of the speakers.

### Step 3: Fine-tuning for Persons of Interest

After training, the network is further fine-tuned using data from “persons of interest” that is individuals whom the agency is particularly interested in identifying. Fine-tuning allows the model to become more specialized in recognizing these individuals with a higher degree of accuracy.

### Step 4: Embedding Storage Using k-d Tree Structures

Embeddings from the voice samples of all persons of interest are stored in a data structure known as a k-d tree. These trees allow for quick nearest-neighbour searches, making it possible to efficiently compare embeddings of new audio samples with those already stored. Each person of interest has embeddings corresponding to specific utterances, which are stored in a series of k-d trees, one for each utterance, and a mean k-d tree storing average embeddings for each individual.

### Step 5: Receiving and Processing New Audio

When a new audio sample is uploaded (e.g., from a recorded conversation), the system processes the sample through the pre-trained transformer-based model to generate its embeddings. These embeddings are then compared to those stored in the k-d tree structures to find the nearest neighbour embeddings from the dataset that are closest to the new audio sample.

### Step 6: Nearest Neighbour Search and Identification

If the distance between the new audio's embedding and the nearest stored embedding (from the k-d tree) is below a predefined threshold, the system concludes that the speaker in the new audio is likely the same individual as the nearest neighbour with a high degree of confidence. This process is repeated across multiple k-d trees.

### Step 7: Validation Across Multiple Trees

To ensure robust identification, the system performs the nearest neighbour search across multiple k-d trees. It also considers the mean k-d tree, which stores the average embeddings of each person of interest. If the new audio's embedding is consistently among the top-k nearest neighbours in a significant percentage (e.g., x%) of the k-d trees, the system confirms the identity of the speaker.

### Step 8: Mimicry Detection

To verify whether the identified speaker's voice is real or mimicry, the system utilizes the triplet loss function. Fine-tuning during training has made the embeddings for real voice samples and mimicry samples separable meaning the distance between embeddings of real and mimicry samples is large. By setting a distance threshold, the system can accurately detect whether the new audio is genuine or mimicry.

### Example Result

A new audio recording is processed by the system. The nearest neighbour search reveals that the speaker's voice matches that of a known suspect stored in the database. The system calculates the distance between the embeddings of the new audio sample and those in the k-d tree, determining that the voice is highly likely to belong to the suspect. Additionally, the triplet loss function confirms that the voice is genuine, not a mimicry.

This method enables the agency to confidently identify the speaker from the audio recording, streamlining the investigation process while minimizing the risk of error. Let us delve into another detailed working example of the present disclosure.

Consider a scenario where a law enforcement agency needs to identify whether a voice in a given audio recording belongs to a specific individual from a known list of suspects and whether the voice is real or mimicry. The system must process the input audio, analyse it to generate embeddings and compare them with known samples to provide a high-confidence result.

### Step 1: Receiving Input Audio File

The system receives an audio file from an ongoing investigation, which contains a recorded conversation. This audio file is provided in a standard audio format, such as WAV or MP3.

An investigator uploads the audio file through the system's user interface, triggering the processor to start the identification process.

### Step 2: Splitting the Audio File

The processor splits the audio file into chunks of 5 seconds each.

This division facilitates the analysis of smaller segments of audio, allowing the system to focus on distinct portions of speech.

Example Output: The audio file is divided into several chunks, such as:

Chunk 1:0:00 to 0:05

Chunk 2:0:05 to 0:10

Chunk 3:0:10 to 0:15

(and so on . . .)

### Step 3: Providing Chunks to a Pre-trained Audio Transformer

Each chunk is then provided to a pre-trained transformer-based audio processing model, such as an Audio Spectrogram Transformer. This model processes each audio segment to extract embedding vectors, which represent the unique characteristics of the speaker's voice, such as pitch, cadence, and tone.

For each audio chunk, the transformer generates an embedding vector of a fixed dimension (e.g., 768). These embeddings serve as the foundation for comparing the current voice sample with known embeddings in the dataset.

### Step 4: Identifying Nearest Neighbours

The generated embedding vectors are then compared against pre-stored embeddings in a k-d tree structure that contains voice samples from a list of known individuals (e.g., suspects). The k-d tree allows for efficient nearest-neighbour searches based on the embeddings.

From the identified nearest neighbours, the processor selects those whose distances from the input embedding are less than a predefined nearest-neighbour distance threshold.

If the threshold is set to 0.5 (in the embedding space), only those nearest neighbours falling within this range are considered.

The processor identifies that Chunk 1 is primarily associated with Speaker A.

The system identifies the nearest neighbour embeddings from the k-d tree, which correspond to the individuals of interest. If the distance between the generated embedding and a stored embedding is below a pre-defined threshold, the system identifies a match with high confidence.

### Step 5: Identifying a Set of Nearest Neighbours

The system further applies a mimicry detection algorithm using the triplet loss function. This algorithm ensures that embeddings of real and mimicry voices are distinguishable by their distances. If the distance between embeddings of a real voice sample is small, the system verifies it as authentic. Conversely, if the distance between a real voice and a mimicry voice is large, it flags the sample as mimicry.

The system determines that the voice in the audio file belongs to one of the suspects and is not a mimicry, based on the separability of the embeddings.

### Step 6: Determining the Specific Person of Interest

The processor counts the number of nearest neighbours identified in the previous step. If this count exceeds a predefined k-d tree threshold (e.g., 3), the specific person of interest is confirmed.

If the processor finds that Chunk 1 has a count of 4 nearest neighbours meeting the threshold, it confidently identifies the speaker as Speaker A.

After identifying the speaker and confirming the authenticity of the voice, the system provides the final result to the investigator, identifying the specific person of interest. The identification is based on the top-k nearest neighbours across multiple k-d trees, ensuring robustness in the decision-making process.

The system presents the investigator with the identification result, confirming that the voice in the recording belongs to “Suspect X” and is a genuine recording, not a mimicry.

This detailed working example demonstrates how the disclosed method processes an audio file, analyzes it using advanced transformer-based models, and utilizes k-d tree structures for efficient speaker identification. The method also ensures high accuracy in distinguishing real voices from mimicry, providing a robust solution for critical applications such as law enforcement and security.

Let us delve into another detailed working example of the present disclosure.

Consider a scenario where a security agency is tasked with identifying a speaker from an audio recording of a conversation. The goal is to match the speaker's voice with known suspects, using pre-trained machine learning models, and determine whether the voice is real or mimicry.

In this case, the security agency could deploy a portable device (104) configured with the present system. The input audio file, containing the conversation, is received via the device's UI. The processor (201) then splits the input audio file into chunks and extracts key audio features, which are used to generate embeddings of each chunk via a transformer encoder model.

Next, the classification unit (209) utilizes these embeddings to search for nearest neighbours within the stored data, representing known voices of suspects. The classification unit (209) evaluates these nearest neighbours by calculating their distances within the embedding space and identifies whether any of the suspects'voices closely match the speaker in the audio recording. If the set of nearest neighbours surpasses a predefined count threshold and their distances are less than the predefined nearest-neighbour distance threshold, the system confirms the identification of the speaker.

Additionally, the classification unit (209) may assess whether the identified chunks correspond to real audio or mimicry, using techniques such as cross-entropy and triplet loss. This ensures that the identified voice is authentic, thereby assisting the security agency in determining the validity of the speaker's voice, improving both the reliability and accuracy of the identification process.

Overall, the disclosed method not only streamlines the process of speaker identification in audio files but also enhances accuracy by leveraging advanced machine learning techniques. By effectively segmenting audio data, generating high-dimensional embeddings, and utilizing nearest neighbour algorithms, the method allows for precise differentiation between speakers. This capability is particularly beneficial in applications such as virtual meetings, voice recognition systems, and audio transcription services, where clarity and accuracy of speaker attribution are crucial. Furthermore, the system's adaptability to various audio formats and its efficiency in processing large datasets make it a valuable tool for developers and researchers working in the fields of audio analysis and machine learning.

A person skilled in the art will understand that the scope of the disclosure is not limited to scenarios based on the aforementioned factors and using the aforementioned techniques, and that the examples provided do not limit the scope of the disclosure.

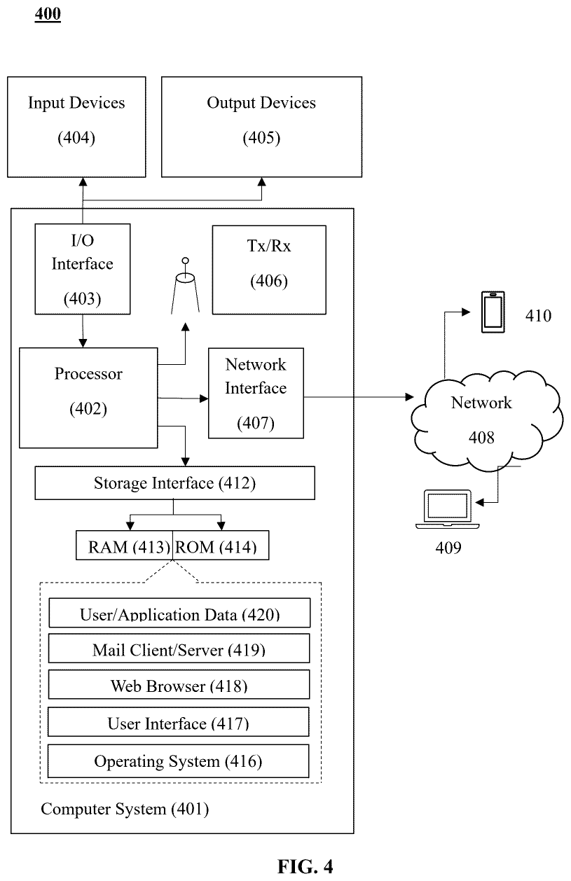

FIG. 4 illustrates a block diagram of an exemplary computer system (401) for implementing embodiments consistent with the present disclosure.

Variations of a computer system (401) may be used for withdrawal of a user from the environment. The computer system (401) may comprise a central processing unit (“CPU” or “processor”) (402). The processor (402) may comprise at least one data processor for executing program components for executing user or system generated requests. A user may include a person, a person using a device such as those included in this disclosure, or such a device itself. Additionally, the processor (402) may include specialized processing units such as integrated system (bus) controllers, memory management control units, floating point units, graphics processing units, digital signal processing units, or the like. In various implementations, the processor (402) may include a microprocessor, such as AMD Athlon, Duron or Opteron, ARM's application, embedded or secure processors, IBM PowerPC, Intel's Core, Itanium, Xeon, Celeron or other line of processors, for example. Accordingly, the processor (402) may be implemented using a mainframe, distributed processor, multi-core, parallel, grid, or other architectures. Some embodiments may utilize embedded technologies like application-specific integrated circuits (ASICs), digital signal processors (DSPs), or Field Programmable Gate Arrays (FPGAs), for example.

Processor (402) may be disposed of in communication with one or more input/output (I/O) devices via an I/O interface (403). Accordingly, the I/O interface (403) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like, for example.

Using the I/O interface (403), the computer system (401) may communicate with one or more I/O devices. For example, the input device (404) may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, or visors, for example. Likewise, an output device (405) may be a user's smartphone, tablet, cell phone, laptop, printer, computer desktop, fax machine, video display (e.g., cathode ray tube (CRT), liquid crystal display (LCD), light-emitting diode (LED), plasma, or the like), or audio speaker, for example. In some embodiments, a transceiver (406) may be disposed in connection with the processor (402). The transceiver (406) may facilitate various types of wireless transmission or reception. For example, the transceiver (406) may include an antenna operatively connected to a transceiver chip (example devices include the Texas Instruments® WiLink WL1283, Broadcom® BCM4750IUB8, Infineon Technologies® X-Gold 618-PMB9800, or the like), providing IEEE 802.11a/b/g/n, Bluetooth, FM, global positioning system (GPS), and/or 2G/3G/5G/6G HSDPA/HSUPA communications, for example.

In some embodiments, the processor (402) may be disposed in communication with a communication network (408) via a network interface (407). The network interface (407) is adapted to communicate with the communication network (408). The network interface (407) may employ connection protocols including, without limitation, direct connect, Ethernet (e.g., twisted pair 10/100/1000 Base T), transmission control protocol/internet protocol (TCP/IP), token ring, or IEEE 802.11a/b/g/n/x, for example. The communication network (408) may include, without limitation, a direct interconnection, local area network (LAN), wide area network (WAN), wireless network (e.g., using Wireless Application Protocol), or the Internet, for example. Using the network interface (407) and the communication network (408), the computer system (401) may communicate with devices such as shown as a laptop (409) or a mobile/cellular phone (410). Other exemplary devices may include, without limitation, personal computer(s), server(s), fax machines, printers, scanners, various mobile devices such as cellular telephones, smartphones (e.g., Apple iPhone, Blackberry, Android-based phones, etc.), tablet computers, desktop computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system (401) may itself embody one or more of these devices.

In some embodiments, the processor (402) may be disposed in communication with one or more memory devices (e.g., RAM 413, ROM 414, etc.) via a storage interface (412). The storage interface (412) may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, or solid-state drives, for example.

The memory devices may store a collection of program or database components, including, without limitation, an operating system (416), user interface application (417), web browser (418), mail client/server (419), user/application data (420) (e.g., any data variables or data records discussed in this disclosure) for example. The operating system (416) may facilitate resource management and operation of the computer system (401). Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

The user interface (417) is for facilitating the display, execution, interaction, manipulation, or operation of program components through textual or graphical facilities. For example, user interfaces (417) may provide computer interaction interface elements on a display system operatively connected to the computer system (401), such as cursors, icons, check boxes, menus, scrollers, windows, or widgets, for example. Graphical user interfaces (GUIs) may be employed, including, without limitation, Apple Macintosh operating systems'Aqua, IBM OS/2, Microsoft Windows (e.g., Aero, Metro, etc.), Unix X-Windows, or web interface libraries (e.g., ActiveX, Java, JavaScript, AJAX, HTML, Adobe Flash, etc.), for example.

In some embodiments, the computer system (401) may implement a web browser (418) stored program component. The web browser (418) may be a hypertext viewing application, such as Microsoft Internet Explorer, Google Chrome, Mozilla Firefox, Apple Safari, or Microsoft Edge, for example. Secure web browsing may be provided using HTTPS (secure hypertext transport protocol), secure sockets layer (SSL), Transport Layer Security (TLS), or the like. Web browsers may utilize facilities such as AJAX, DHTML, Adobe Flash, JavaScript, Java, or application programming interfaces (APIs), for example. In some embodiments the computer system (401) may implement a mail client/server (419) stored program component. The mail server (419) may be an Internet mail server such as Microsoft Exchange, or the like. The mail server may utilize facilities such as ASP, ActiveX, ANSI C++/C #, Microsoft. NET, CGI scripts, Java, JavaScript, PERL, PHP, Python, or WebObjects, for example. The mail server (419) may utilize communication protocols such as internet message access protocol (IMAP), messaging application programming interface (MAPI), Microsoft Exchange, post office protocol (POP), simple mail transfer protocol (SMTP), or the like. In some embodiments, the computer system (401) may implement a mail client (420) stored program component. The mail client (420) may be a mail viewing application, such as Apple Mail, Microsoft Entourage, Microsoft Outlook, or Mozilla Thunderbird.

In some embodiments, the computer system (401) may store user/application data (421), such as the data, variables, records, or the like as described in this disclosure. Such databases may be implemented as fault-tolerant, relational, scalable, secure databases such as Oracle or Sybase, for example. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

Various embodiments of the disclosure encompass numerous advantages including methods and systems for identifying the speaker in the audio file. The disclosed method and system have several technical advantages, but not limited to the following:
High Accuracy in Speaker Identification: The use of transformer-based audio processing models, such as Audio Spectrogram Transformers, provides robust and precise generation of speaker embeddings, allowing the system to identify speakers with high accuracy even in noisy or complex audio environments.
Efficient Processing via k-d Tree Structures: The system utilizes k-d tree structures for fast and efficient nearest-neighbor searches, significantly reducing the time required to compare a new audio sample with pre-stored embeddings from a large dataset. This enables real-time or near-real-time speaker identification.
Mimicry Detection Capability: By leveraging triplet loss and cross-entropy loss functions, the system can effectively differentiate between real and mimicry voice samples, offering a critical advantage in scenarios where voice authentication or anti-spoofing measures are needed.
Scalability and Adaptability: The system is scalable, supporting large datasets of voice samples for multiple individuals, while also allowing fine-tuning for specific persons of interest. This adaptability makes it applicable across various use cases, from law enforcement to virtual meetings and beyond.
Modular and Extendable Design: The architecture can incorporate different types of audio processing transformers and datasets, making it flexible for a range of applications, including detecting fake audio, identifying voice samples from diverse sources, or adding custom models tailored to particular use cases.
Efficient Handling of Large Audio Files: The system's ability to split large audio files into manageable chunks ensures that even lengthy recordings can be processed effectively, without overwhelming the system or compromising accuracy in identification.
Real-Time User Feedback: The system provides real-time feedback and results to the user through a user-friendly interface, which can display information about the identified speaker, the authenticity of the voice sample, and other key details in an intuitive format.
Reduction in Manual Intervention: The automated nature of the system, powered by advanced machine learning models, reduces the need for manual intervention in speaker identification processes, streamlining operations and minimizing human errors.

In summary, these technical advantages solve the technical problem of providing a reliable and efficient system for identifying speakers in audio files, including detecting whether a voice sample is authentic or mimicry. By utilizing advanced audio processing models, such as transformer-based networks, combined with efficient k-d tree structures for nearest-neighbour searches, the system addresses the challenges of real-time speaker identification in complex audio environments. It further enhances security by incorporating mechanisms to distinguish real voice samples from mimicry, reducing the risk of voice-based impersonation and improving overall accuracy in voice authentication systems.

The claimed invention of the system and the method for identifying the speaker in the audio file addresses the need for a robust and accurate speaker identification mechanism, particularly in environments where audio recordings may contain multiple speakers, and the authenticity of the voice samples is critical. This system and method enable users to efficiently analyse voice samples, distinguish between real and mimicry voices, and accurately attribute the speech to the correct individual from a set of candidates. By leveraging advanced techniques like transformer-based neural networks for embedded generation and nearest neighbour search algorithms, the system ensures high accuracy in speaker identification. The invention includes the use of a pre-trained audio transformer, k-d tree structures for fast nearest neighbour searches, and a fine-tuning mechanism to improve the model's performance for specific individuals. Additionally, it incorporates cross-entropy and triplet loss functions for enhancing the separation of real and mimicry voice embeddings, enabling reliable mimicry detection. By incorporating these advanced features, the invention provides a scalable and efficient solution for real-world applications such as digital meetings, security systems, and voice-based authentication platforms. It ensures that voice samples are correctly identified, and if required, authenticates whether the sample belongs to the intended individual or is an impersonation attempt.

Furthermore, the invention involves a non-trivial combination of technologies and methodologies that provide a technical solution for a technical problem—specifically, the challenge of identifying speakers in audio files and determining the authenticity of voice samples in a scalable manner. While individual components like processors, transformers, and k-d tree structures are well-known in the field of computer science, their integration into a comprehensive system for identifying a speaker in an audio file brings about an improvement and technical advancement in the field of audio signal processing, machine learning, and voice biometrics. This combination enables the system to handle complex datasets, extract meaningful features, and process voice samples efficiently without manual intervention, improving both accuracy and performance in speaker identification tasks.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications. Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments falling within the scope of the appended claims.

1. A method (300) for identifying a speaker of interest in an audio file, the method
(300) comprising:
receiving (301), via a processor (201), an input audio file;
splitting (302), via the processor (201), the input audio file into one or more chunks;
extracting (303), via the processor (201), one or more features corresponding to each chunk from the one or more chunks;
generating (304), via the processor (201), embeddings of one or more speakers, using a transformer encoder model based on the extracted one or more features;
identifying (305), via the processor (201) coupled with a classification model, one or more nearest neighbours, from one or more data structures corresponding to each person from one or more persons, based on the generated embeddings;
identifying (306), via the processor (201), a set of nearest neighbours from the one or more nearest neighbours, corresponding to a person from the one or more persons, with a count of the set of nearest neighbours greater than a predefined threshold,
wherein a distance of each of the set of nearest neighbours is less than a predefined nearest-neighbour distance threshold; and
providing (307), via the processor (201), an identification of the speaker of interest as the person from the one or more persons.

2. The method (300) as claimed in claim 1, comprises preprocessing the received input audio file before the splitting (301), wherein preprocessing corresponds to sampling the received input audio file based on a predefined sampling rate, to obtain a sampled input audio file; wherein the method (300) comprises filtering the sampled input audio file in the time domain to reduce either noise or artifacts in the frequency domain, wherein the filtering of the sampled input audio file is performed using one of hamming window, hanning window, low pass filter, high pass filter, band pass filter or a combination thereof, wherein the method (300) comprises preprocessing the received input audio file to identify one or more portions associated with the one or more speakers, within the received input audio file.

3. The method (300) as claimed in claim 1, wherein the input audio file comprises audio samples of the one or more speakers, wherein the splitting (302) of the input audio file into the one or more chunks is performed using a pre-defined time interval, or using the audio samples of the one or more speakers, wherein each chunk from the one or more chunks, obtained by the splitting (302), is partially overlapping with an adjacent chunk of the one or more chunks.

4. The method (300) as claimed in claim 1, wherein the one or more features comprises one of a mel spectrogram, vocal tract model parameters, acoustic parameters, background noise, raw sample, pitch, frequency changes, file format or a combination thereof.

5. The method (300) as claimed in claim 1, comprises stacking the extracted one or more features before passing to a feeder neural network model, to create a volume of input to the feeder neural network model; wherein the method (300) comprises providing the extracted one or more features, to the feeder neural network model based on the created volume of input, before passing to the transformer encoder model, for obtaining a changed activation volume of an input of the transformer encoder model.

6. The method (300) as claimed in claim 3, wherein the classification model is trained on a dataset of voice samples, wherein the dataset of voice samples comprises the audio samples of the one or more speakers, embeddings of the one or more speakers, labelled mimicry samples of the one or more speakers, wherein the method (300) comprises, during the training, utilizing one or more loss functions on the dataset of voice samples, to identify a wrong classification and further update the classification model using a back propagation technique, wherein the one or more loss functions comprise a cross-entropy loss model, a triplet loss model, L2 regularizer or a combination thereof.

7. The method (300) as claimed in claim 6, wherein the dataset comprises the one or more data structures, wherein the one or more data structures corresponds to one of one or more k-d tree structures, Ball tree, Quadtree, Octree, hierarchical data structure, hash maps, graph-based structure, multi-dimensional arrays, indexed database or a combination thereof, wherein the one or more k-d tree structures comprise a set of k-d tree structures and a set of mean k-d tree structures, wherein the set of k-d tree structures correspond to embeddings of utterances of the each person from the one or more persons, and wherein the set of mean k-d tree structures corresponds to mean embeddings of the each person from the one or more persons.

8. The method (300) as claimed in claim 5, wherein the feeder neural network model corresponds to at least one of a convolutional neural network (CNN) layers, fully connected layers, sigmoid activation, ReLU (Rectified Linear Unit) activation, dropout layers, ResNet (Residual Networks), RawNet2, Deep Neural Network (DNN), or a combination thereof.

9. The method (300) as claimed in claim 6, wherein the transformer encoder model is trained using the dataset of voice samples for identifying the speaker of interest, wherein the embeddings generated by the transformer encoder model are multi-dimensional vector representation of each chunk of the one or more chunks, wherein the transformer encoder model corresponds to one of an Audio Spectrogram Transformer, a Whisper Transformer Encoder, a Wave2Vec Transformer, or a custom transformer-based neural network model, EnCodec, Hubert (Hidden-Unit BERT) or a combination thereof designed for audio processing.

10. The method (300) as claimed in claim 7, wherein the classification model is trained using the dataset of voice samples comprising the one or more k-d tree structures, wherein the classification model is configured to obtain a distance of each embedding from the embeddings of the one or more speakers with embeddings of the one or more k-d tree structures, wherein the classification model is configured to compare the distance of each embedding from the embeddings of the one or more speakers with the predefined nearest-neighbour distance threshold to identify the one or more nearest neighbours; wherein the classification model corresponds to one of logistic regression, random forest, k-nearest neighbour (k-NN), support vector machines (SVM), or a combination thereof.

11. The method (300) as claimed in claim 7, wherein predefined threshold is indicative of a predefined percentage of a combination of a count of the set of k-d tree structures and a count of the set of mean k-d tree structures corresponding to the person from the one or more persons.

12. The method (300) as claimed in claim 2, comprises receiving one or more portions associated with a speaker from the one or more speakers for identifying of the speaker of interest, wherein the one or more portions associated with the speaker is selected by a user.

13. The method (300) as claimed in claim 1, wherein the identification of the speaker of interest comprises information about the person from the one or more persons, wherein the information about the person from the one or more persons corresponds to whether the speaker of interest is a real audio of the person or a mimicry of the person.

14. A system (100) for identifying a speaker of interest in an audio file, wherein the
system (100) comprises:
a processor (201);
a memory (202) communicatively coupled with the processor (201), wherein the memory (202) is configured to store one or more executable instructions that, when executed by the processor (201), cause the processor (201) to:
receive an input audio file;
split the input audio file into one or more chunks;
extract one or more features corresponding to each chunk from the one or more chunks;
generate embeddings of one or more speakers, using a transformer encoder model based on the extracted one or more features;
identify, via a classification model, one or more nearest neighbours, from one or more data structures corresponding to each person from one or more persons, based on the generated embeddings;
identify a set of nearest neighbours from the one or more nearest neighbours, corresponding to a person from the one or more persons, with a count of the set of nearest neighbours greater than a predefined threshold,
wherein a distance of each of the set of nearest neighbours is less than a predefined nearest-neighbour distance threshold; and
provide an identification of the speaker of interest as the person from the one or more persons.

15. A non-transitory computer-readable storage medium having stored thereon a set of computer-executable instructions that, when executed by a processor (201), cause the processor (201) to perform steps comprising:
receiving (301) an input audio file;
splitting (302) the input audio file into one or more chunks;
extracting (303) one or more features corresponding to each chunk from the one or more chunks;
generating (304) embeddings of one or more features, using a transformer encoder model based on the extracted one or more features;
identifying (305), via a classification model, one or more nearest neighbours, from one or more data structures corresponding to each person from one or more persons, based on the generated embeddings;
identifying (306) a set of nearest neighbours from the one or more nearest neighbours, corresponding to a person from the one or more persons, with a count of the set of nearest neighbours greater than a predefined threshold,
wherein a distance of each of the set of nearest neighbours is less than a predefined nearest-neighbour distance threshold; and
providing (307) an identification of the speaker of interest as the person from the one or more persons.
